(19) United States
(12) Patent Application Publication
(10) Pub. No.: US 2007/0139524 A1
(43) Pub. Date: Jun. 21, 2007

(54) Method of determining the cause of an error state in an apparatus

(75) Inventor: Bradley L. Lozler, Centerville, OH (US)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/305,757

(22) Filed: Dec. 16, 2005

(51) Int. Cl. H04N 7/18

(52) U.S. Cl. 348/150

(57) ABSTRACT

A method is described for determining the cause of an error state for one or more components within an apparatus. The system for detecting the cause of an error state for, at least, one component within an apparatus comprises a plurality of video cameras, for placement at pre-determined locations within the apparatus. The cameras are arranged to shoot footage of areas of the apparatus whilst in operation. The system also comprises a memory for storing the footage and a display arranged to display, at least, a selection the footage.

The invention relates to a method of determining the cause of an error state in an apparatus, and has particular application, for example, to use in determination of errors in self service terminals (SST) such as automated teller machines (ATM).

### BACKGROUND

As the invention has particular application to the analysis of causes of error states in a remote device such as an ATM. A remote device is defined as any device normally operated by individuals that are not directly responsible for or trained to repair that device. As such a remote device encompasses devices from photocopiers to motorcars. Therefore, for the sake of clarity, the invention will be described with reference to an ATM.

A standard ATM having the facility to dispense bank notes includes electronic control means connected to both a currency dispenser unit and a user interface device. As is well known, in operation of such an ATM a user inserts a user identity card into the machine and then enters certain data, such as a personal identification number (PIN) and the quantity of currency required to be dispensed, by means of a key pad incorporated in the user interface device. The ATM will then process the requested transaction, dispense notes extracted from one or more storage cassettes within the currency dispenser unit, update the user's account to reflect the transaction and return the card to the user as part of a routine operation.

In operation of an ATM, various malfunctions may occur from time to time. For example, bank notes may become jammed in the feed path, the pick means, utilized to select a note from an ATM currency cassette, may fail to pick a bank note from the associated storage cassette, or there may occur multiple feeding in which two or more notes are fed in superposed relationship to the stacking means.

The problems discussed above may be caused by wear of components in the dispenser unit or by changes in the ambient conditions in the vicinity of the ATM.

When ATM malfunctions, such as those discussed above, occur the ATM may be shut down until the malfunction is rectified, which will require the intervention of a trained operator, or in the event of multiple feeding the picked notes will be diverted to a purge bin resulting in less efficient operation of the ATM.

These problems have to-date been addressed by a sensor system arranged to monitor the condition of ATM components, at any given time, in which raw device status information is sent to a management system. There is, however, only limited information which is provided by the sensors which are presently utilized within an ATM. This results in field engineers being sent to ATMs to ascertain the situation with the ATM prior to fixing it. As these engineers are required to determine the problem with the apparatus they must be reasonably skilled individuals. In addition, although the apparatus sensors can indicate that an error, such as a media jam in the transport path of an ATM, has occurred they are limited when it comes to indicating what caused the jam as this would only be possible had the jam been witnessed.

### SUMMARY

It is among the objects of the present invention to ameliorate the problems discussed above.

According to a first aspect of the present invention there is provided a system for detecting the cause of an error state for, at least, one component within an apparatus, the system comprising: a plurality of video cameras, for placement at pre-determined locations within the apparatus, the cameras being arranged to shoot footage of areas of the apparatus whilst in operation; a memory for storing the footage; and a display arranged to display, at least, a selection the footage.

According to a second aspect of the present invention there is provided an Automated Teller Machine (ATM) comprising a system for detecting the cause of an error state for, at least, one component within an apparatus, the system comprising: a plurality of video cameras, for placement at pre-determined locations within the apparatus, the cameras being arranged to shoot footage of areas of the apparatus whilst in operation; a memory for storing the footage; and a display arranged to display, at least, a selection the footage.

According to a third aspect of the present invention there is provided a method of detecting the cause of an error state for, at least, one component within an apparatus, the system comprising: a plurality of video cameras, for placement at pre-determined locations within the apparatus; a memory for storing the footage; and a display arranged to display, at least, a selection the footage; the method comprising arranging the cameras to shoot footage of areas of the apparatus whilst in operation and to provide, at least, a selection of that footage to the display when an error state is detected within the apparatus.

### BRIEF DESCRIPTION OF THE DRAWINGS

These and other aspects of the invention will be apparent from the following specific description, given by way of example, with reference to the accompanying drawings, in which:

FIG. 1 is a perspective view of an ATM capable of utilizing a system and method in accordance with the present invention;

FIG. 2 is a side elevation of a cash dispenser unit of the ATM of FIG. 1, the dispenser unit having two pick means, and parts of said unit being omitted for the sake of simplicity;

FIG. 3 is an enlarged side elevation of one of the pick means of FIG. 2; and

FIG. 4 is a block circuit diagram of the ATM of FIG. 1;

FIG. 5 is an overview of one embodiment of a system of determining error states in an ATM which can be utilized in a method in accordance with the present invention.

### DETAILED DESCRIPTION

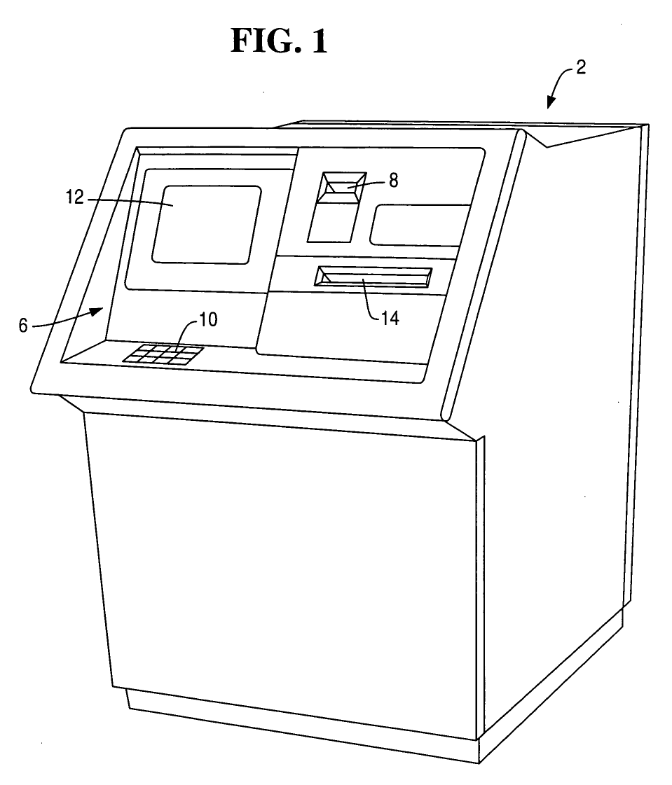

Prior to discussing the method and apparatus in accordance with the present invention in more detail the structure and operation of an ATM will be described, including an existing sensor system, in order to understand operational problems which may occur within an ATM and the sensor outputs they produce (FIGS. 1 to 4). Thereafter, the use of video cameras in accordance with the present invention will be described.

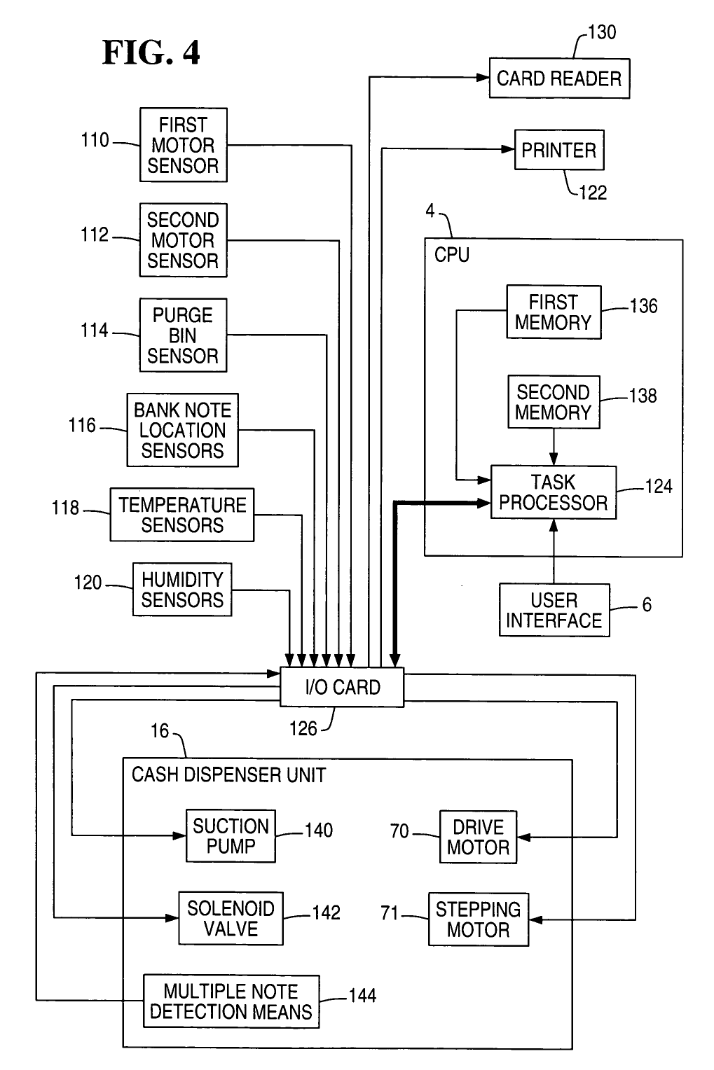

With reference to FIGS. 1 and 4 there is illustrated an ATM 2, which includes a control means in the form of a central processor unit (CPU) 4 which has stored therein a control program which controls the operation of the ATM 2 in dependence upon information gained from a plurality of sensors 110-120. If sensors are added or removed from the terminal 2 the program may be updated. The program monitors and optimizes the operation of the ATM 2.

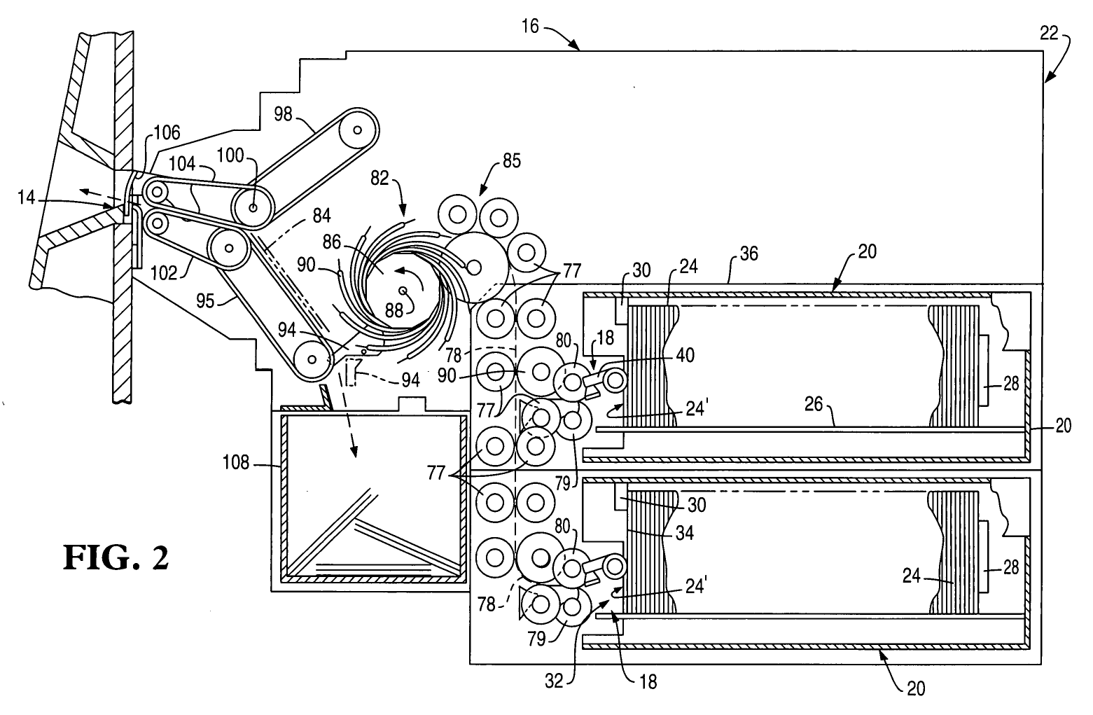

The CPU 4 is connected to a user interface device 6 incorporating a slot 8 (FIG. 1), connected to a conventional card reader 130 (FIG. 4), for receiving a user identity card, a key pad 10 for inputting data, a screen 12 for displaying user information, and an output slot 14 for dispensing bank notes to a user. The CPU 4 is also connected to a cash dispenser unit 16 (FIG. 2) and a conventional printer 122 (FIG. 4) for printing documents such as statements, receipts and account balances.

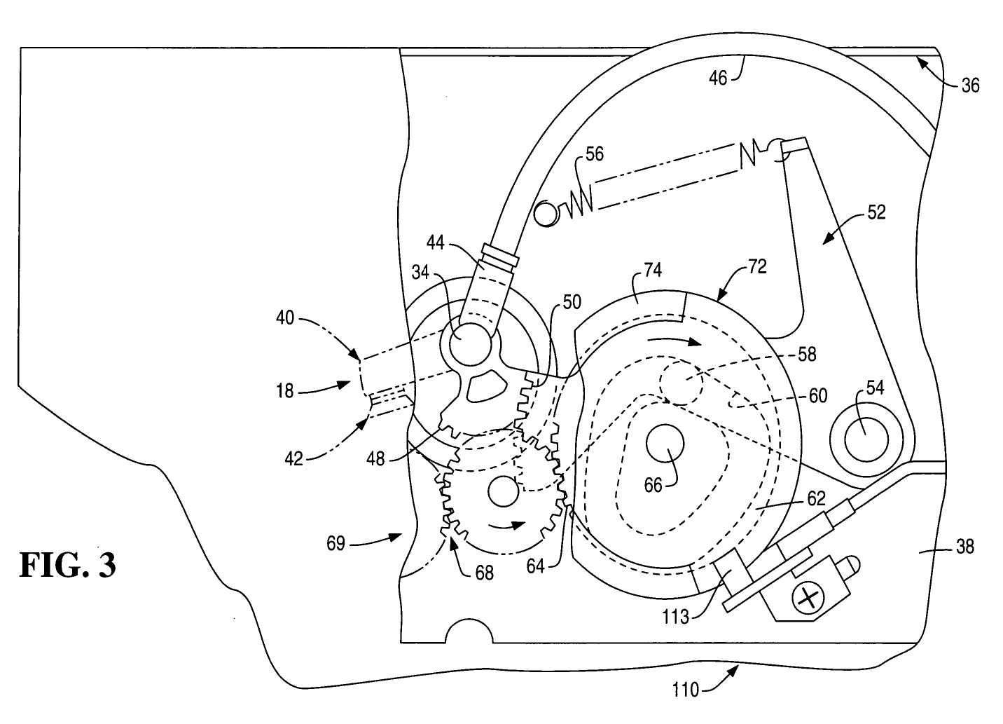

Referring particularly to FIGS. 2 and 3, the cash dispenser unit 16 includes two similar pick means 18 arranged one above the other and respectively associated with two storage cassettes 20 which are removably mounted in a supporting framework 22 of the dispenser unit 16. Each of the storage cassettes 20 is arranged to contain a stack of bank notes 24, corresponding long edges of which are supported on a horizontal support plate 26 mounted in the storage cassette 20. The stack of notes 24 in each storage cassette 20 is urged by a spring loaded pusher member 28 towards a stop member 30 mounted at the front end of each storage cassette 20. An opening 32 is formed in the front end of each storage cassette 20, the opening 32 being closed normally by conventional shutter means (not shown) when the storage cassette 20 is not mounted in the dispenser unit 16. When a storage cassette 20 is mounted correctly in the dispenser unit 16, the shutter is automatically retracted to enable notes 24 to be extracted through the opening 32 by the associated pick means 18.

Each pick means 18 includes a tubular member 34 which extends between, and is rotatably mounted with respect to, side walls 36 and 38 (FIG. 3) of the framework 22. Two conventional pick arms 40, each incorporating a rubber suction pad 42, are secured on each tubular member 34, each pick arm 40 communicating with the interior of the associated tubular member 34. Corresponding ends of the tubular members 34 project beyond the side wall 38, and are each connected by a respective swivel elbow connector 44 to a respective rubber tube 46 via which reduced pressure is applied in operation to the respective tubular member 34. The suction force produced by the suction pump 140 (FIG. 4) is applied to a first note 24′ in the stack of notes 24 in the storage cassette 20 via the tubular members 34 and suction pads 42, when the suction pads 42 are in contact with the first note 24′ and a solenoid valve 142 (FIG. 4) located between the suction pump 140 and the suction pads 42 is opened.

A gear segment 48 is secured to that part of each tubular member 34 projecting beyond the side wall 38, the gear segment 48 being in co-operative engagement with a toothed end portion 50 of a first arm of a respective bell crank lever 52 which is pivotably mounted on a stud 54 secured to the outer surface of the wall 38. Each lever 52 is urged to rotate in a counter clockwise direction with reference to FIG. 3 by means of a spring 56 the ends of which are respectively attached to the side wall 38 and to the end of the second arm of the lever 52. A stud 58 is secured to one side of each lever 52, the stud 58 engaging in a cam track 60 formed in an associated cam member 62. Each cam member 62 is secured to a respective gear wheel 64 which is rotatably mounted on a respective shaft 66 projecting from the outer surface of the side wall 38. The gear wheels 64 are driven by gear wheels 68 forming part of a gear mechanism 69 operated by a main electric drive motor 70 (FIG. 4). In operation (with the drive motor 70 energized) the gear wheels 64 are rotated in a clockwise direction with reference to FIG. 3. This rotation of the gear wheels 64 brings about an oscillatory pivotal movement of the levers 52 by virtue of the engagement of the studs 58 in the cam tracks 60, the springs 56 holding the studs 58 in engagement with the inner edges of the cam tracks 60. By virtue of the engagement of the gear segments 44 with the toothed portions 50 of the levers 52, the oscillatory movement of the levers 52 brings about an oscillatory pivotal movement of the assemblies of the tubular members 34 and the associated pick arms 40. As will be explained in more detail later, the oscillatory movement of either of the assemblies of the tubular members 34 and the associated pick arms 40 is effective to cause notes 24 to be picked one by one from the stack of notes 24 held in the associated storage cassette 20.

The ATM 2 incorporates a motor sensor 110 which includes a timing disc 72 (FIG. 3) secured to the face of each gear wheel 60 remote from an associated cam member 62. The timing disc 72 is for the most part transparent but incorporates an arcuate opaque strip 74 extending around just over half the periphery of the disc 72. Each timing disc 72 is associated with optical sensing means, comprising an LED (not shown) and a co-operating photo-transistor sensor 112, which is arranged to sense the opaque strip 74. In operation, as each assembly of a gear wheel 64 and the associated cam member 62 and timing disc 72 rotates in response to energizing of the drive motor 70, the associated sensor 112 generates output signals in response to the sensing of the leading and trailing edges of the associated opaque strip 74. It should be understood that the signals generated by each of the sensors 112 provide indications as to the precise positions of the associated pick arms 40 at the times when these signals are generated.

As the drive motor 70 is a variable speed motor then the speed of rotation of the drive motor 70 can be varied in order to vary the time for which the pick arms 40 hold the associated suction pads 42 in contact with a first note 24′ in the stack of notes 24 in one of the storage cassettes 20, before attempting to pick the first note 24′ from the storage cassette 20. If the solenoid valve 142 is opened just after the suction pads 42 are brought into contact with the first note 24′ then varying the period for which the suction pads 42 are held in contact with the first note 24′ will vary the suction force applied to the first note 24′, as will be discussed in more detail below.

The suction force applied to the first note 24′ prior to attempting to pick the first note 24′ from the storage cassette 20 can also be varied by varying the delay prior to opening the solenoid valve 142 to apply the suction force to the first note 24′. As the suction pump 140 (FIG. 4) operates continuously the longer the delay prior to opening the solenoid valve 142 the larger the suction force produced by the suction pump 140 will be.

Therefore, the suction force used in picking the first note 24′ can be varied by varying either the speed of rotation of the drive motor 70 or varying the delay prior to opening the solenoid valve 142.

The dispenser unit 16 also incorporates feed rollers 77 for feeding the bank notes 24 along a feed path 78 from each of the storage cassettes 20 to a stacking wheel 82 and on to the output slot 14, the rollers 77 being associated with co-operating first and second rollers 79 and 80 which are positioned at the opening 32 in the front of each storage cassette 20.

In the course of a normal pick operation the lower long edge of the first bank note 24′ of the stack of notes 24 in a selected one of the storage cassettes 20 is pulled partly out of the storage cassette 20 under the suction force applied by the respective suction pads 42, and is fed between the associated first and second rollers 79, 80. As the rollers 79, 80 engage the bank note 24′ they urge the note 24′ into the feed path 78 for feeding by the rollers 77.

The stacking wheel 82 is arranged to receive notes 24 fed along the feed path 78. The stacking wheel 82 serves to stack notes 24 picked from one or both of the storage cassettes 20 so as to form a bundle 84 of notes for delivery to the output slot 14 for collection by the user.

The stacking wheel 82 is driven by the drive motor 70 and is arranged to rotate continuously in operation in a counter clockwise direction. Means (not shown) are provided between the upper transport mechanism 85 and the stacking wheel 82 for detecting any multiple feeding of notes and for detecting any invalid or torn note. The stacking plates 86 are spaced apart in parallel relationship along the stacker wheel shaft 88, each stacking plate 86 incorporating a series of curved tines 90. The tines 90 of the stacking plates 86 pass between portions of a rockably mounted stripper plate assembly 94. In operation, each note fed along the feed path 78 to the stacking wheel 82 enters between adjacent tines 90 and is carried partly around the axis of the stacking wheel 82, the note being stripped from the wheel 82 by the portions of the stripper plate assembly 94 and being stacked against belt means 95. The belt means 95 co-operates with belt means 98 normally held in the position shown in FIG. 2. When the bundle of notes 84 (or possibly a single note only) to be dispensed to a user, in response to a cash withdrawal request, has been stacked against the belt means 95, the belt means 98 is rocked in a clockwise direction about a shaft 100 so as to trap the bundle 84 of notes between the belt means 95 and the belt means 98. It should be understood that in the course of this rocking movement separate belts making up the belt means 98 pass between adjacent pairs of the stacking plates 86.

Assuming that none of the notes 24 in the bundle 84 have been rejected for any reason, the belt means 95 and 98 are operated so as to drive the bundle 84 to an adjacent pair of belt means 102 and 104. The belt means 102 and 104 serve to drive the bundle 84 through the output slot 14 to a position where the bundle 84 can be collected by the user of the ATM 2, a shutter 106, which serves to close the slot 14 when the ATM is not in operation, having previously been retracted to an open position.

It should be understood that the belt means 95 and 98 are mounted in resilient relationship relative to each other, and the belt means 102 and 104 are also mounted in resilient relationship relative to each other, so that bundles of notes of varying thickness can be held between, and fed by, the belt means 95 and 98 and the belt means 102 and 104.

The belt means 95, 98,102 and 104 are driven under the control of the CPU 4 by a bi-directional stepping motor 71.

If a multiple feeding has been detected in the course of stacking the bundle of notes 84 against the belt means 95, or if one or more of the notes in the bundle 84 have been rejected for any other reason, then the stripper plate assembly 94 is rocked into the position shown in chain outline in FIG. 2, and the belt means 95 and 98 are operated to feed the bundle 84 in a direction opposite to the normal feed direction, the bundle 84 being deposited in a purge bin 108 via an opening in the top thereof. Also, if a bundle 84 of notes or a single note 24 is misaligned or becomes jammed between the stacking wheel 82 and the output slot 14 then the stepping motor 71 can be operated so as to cause the belt means 95, 98,102 and 104 to drive the note 24 or bundle 84 of notes in the forward and the reverse direction repeatedly, in an attempt to unblock the currency jam or to realign the bank note 24 or bundle 84 of bank notes.

An ATM 2 in accordance with the present invention incorporates a plurality of sensors 110-120 (FIG. 4) in communication with the CPU 4 arranged to monitor the operation of the ATM 2 and the ambient conditions. The CPU 4 is adapted to alter the operation of the ATM 2 in dependence on the output of the sensors 110-120 so as to reduce the number of malfunctions that occur in operation. The sensors 110-120 comprise: a first motor sensor 110 located adjacent the drive motor 70 and a second motor sensor 112 located adjacent the stepping motor 71, the first motor sensor 110 including a photo-transistor sensor 113 (FIG. 3) arranged to detect the speed of the drive motor 70, and the second motor sensor 112 including a photo-transistor sensor (not shown) arranged to detect the speed and rotational direction of the stepping motor 71; a purge bin sensor 114 located adjacent the entrance to the purge bin 108 and arranged to detect the deposition of a single note 24 or a bundle 84 of notes in the purge bin 108; a plurality of optical bank note location sensors 116 located along the feed path 78 and between the stacking wheel 82 and the output slot 14 and arranged to monitor at any instant the presence or absence of notes 24 at different locations within the ATM 2; a plurality of temperature sensors 118 located within the ATM 2, providing the CPU 4 with an accurate measure of the temperatures at selected locations throughout the ATM 2; and a plurality of humidity sensors 120 also located within the ATM 2 so as to provide the CPU 4 with an accurate measure of the ambient humidity at selected locations throughout the ATM 2.

When the ATM 2 is operating, the sensors 110-120 continually monitor the operation of the ATM 2 and ambient conditions and communicate the information obtained to the CPU 4. For example, the temperature sensors 118 may detect that the ambient temperature within the ATM 2 is lower than a predetermined temperature. On receipt of this information the CPU 4 will bring about one or more of a number of actions in order to reduce the likelihood of a malfunction occurring. Thus, for example the CPU 4 may reduce the speed of the drive motor 70 which drives the rollers 77, 79, 80 thereby reducing the likelihood of slippage between a note 24 and the rollers 77, 79, 80 while the note 24 is being fed through the dispenser unit 16. As the drive motor 70 also controls the positioning of the pick arms 40, reducing the speed of the drive motor 70 will cause the rubber suction pad 42 of the pick arms 40 to be held adjacent the first note 24′ in the corresponding storage cassette 20 for an increased period of time thereby increasing the suction force applied to the note 24′. The exact increase in time that the rubber suction pads 42 are held in contact with the first note 24′ prior to picking will depend on the ambient temperature detected by the temperature sensors 118. The time that suction is applied by the suction pads 42 to the first note 24′ is accurately monitored by the CPU 4 through the photo-transistor sensor 112, which detect the speed of rotation of the motor 70 and consequently the location of the pick arms 40 and the associated suction pads 42.

Alternatively, the CPU 4 may increase the suction force applied to the first note 24′ by increasing the delay prior to opening the solenoid valve 142 to apply the suction force to the first note 24′, as discussed above.

The CPU 4 obtains temperature information from each of the temperature sensors 118 which can be processed separately so that the CPU 4 can vary the operation of individual components of the ATM 2 dependent on their temperatures so as to optimize the operation of the ATM 2. For example, a temperature sensor 118 is located in each of the storage cassettes 20 and at various locations throughout the feed path 78. If the first storage cassette 20 is at a higher temperature than the second storage cassette 20 a note 24 will be picked from the second storage cassette 20 more slowly than from the first storage cassette 20 in order to compensate for the lower temperature in the second storage cassette 20. Likewise, the feed means 77 can be controlled differently in different sections of the feed path 78 in order to compensate for differences in ambient temperature detected by the temperature sensors 118 located throughout the feed means 78.

The CPU 4 also monitors by means of the sensor 114 the deposition of a note 24 or a bundle 84 of notes in the purge bin 108. If the CPU 4 finds that the rejection rate is tending to increase then the CPU 4 will cause the speed of the drive motor 70 to be reduced, which action will normally be successful in reducing the rejection rate. Under the control of the control program stored therein, the CPU 4 maintains the time taken to dispense a bundle 84 of notes as low as possible while limiting the number of times that notes 24 are rejected to a predetermined acceptable percentage of total pick operations.

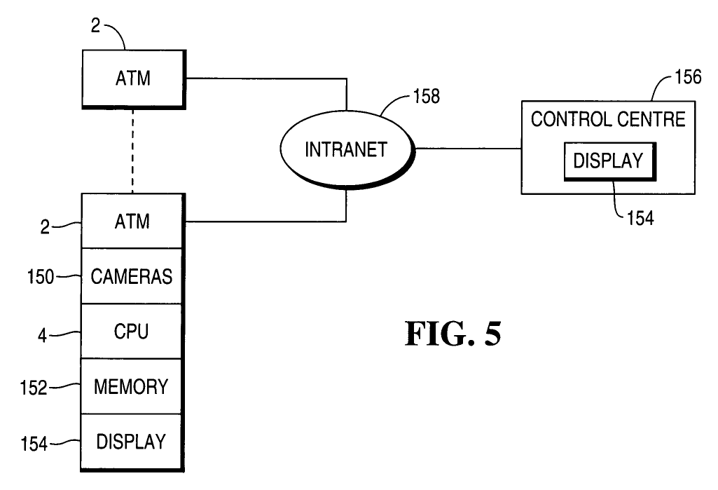

FIG. 5 illustrates an embodiment of a system for detecting the cause of an error state for, at least, one component within an apparatus in the form of an ATM 2, in accordance with the present invention. The system comprises a plurality of video cameras 150, for placement at pre-determined locations within each of the ATM 2 in a network of ATMs. Clearly the system will function for other remote apparatus such as kiosks, automobiles, printers, or photocopiers, and it is described herein with reference to a network of ATMs only as an example.

The cameras 150 are arranged to shoot footage of areas of each ATM whilst in operation, for example in the dispensing of cash to a customer.

The locations of the aforementioned cameras are not illustrated in FIGS. 1 to 4, as those figures primarily illustrate the operation of an ATM. However, they can be located at useful areas throughout the ATM, for example along the media transport path or at the pick mechanism, as would be considered appropriate by a person skilled in the art of ATM design. Preferably, miniature video cameras or recorders are utilized.

The system further comprises a memory 152 for storing the footage in or near the ATM 2 and a display 154 is arranged to display, at least, a selection of the footage. The term “memory” is intended to cover any deice suitable for storing the footage used in determining the cause of the error in the remote device. The display 154 is attached to the ATM in this embodiment. However, it may be located at a remote ATM monitoring centre 156, as will be described below.

The system further comprises a control processor 4, as described above, which is also arranged to determine whether footage is required to be displayed on the display. This determination is made through reviewing the information provided by one or more of the sensors 110-120 the output of which enables the CPU 4 to determine if the ATM 2 has operated properly. For example, if the ATM 2 has dispensed cash to a user without any problem arising then the footage need not be transmitted to the display 154 for presentation to an engineer.

However, if the dispensing action results in, for example, a jam in the transport path then the footage will be forwarded to the display 154, either at the monitoring centre 156 or adjacent the ATM 2, as appropriate. Transmission to the monitoring centre 156 will be accomplished via any appropriate network, such as an intranet 158 to which the ATMs are each coupled.

In one embodiment of the present invention, when an error state is determined the output from the sensors 110-120 is further analyzed to determine the likely location of said error and only footage from cameras 150 in the vicinity of the location of the error is transmitted to the display 154. For example, if a sensor adjacent the stacker 82 indicates that the media has jammed in the vicinity of the stacker wheel 82 then only footage from that area is likely to be of value to the engineer so only footage from that area is transmitted. This both assists with telecommunications bandwidth constraints within the network and also makes it easier for engineers to focus on the problem quickly without having to process irrelevant footage.

Footage from additional locations within the ATM can be displayed on the display 154 on receipt of a request by a user of the system.

If footage is not required to be displayed, as no error state has been determined, then it is over written, in the memory 152, during subsequent operation of the ATM 2, thus saving on memory capacity.

In an embodiment, such as disclosed in FIG. 5, wherein a first display is located in a monitoring centre 156 and a second display is located in the vicinity of the ATM 2, a user at the monitoring centre can determine the fault from the footage when displayed on the first display and a field engineer can also review the footage at the apparatus. This makes it easier for a field engineer, once informed of the probable problem, to confirm the diagnosis provided by his or her colleague in the monitoring centre 156.

In practice the invention provides a tool through which an engineer can make a determination as to the root cause of a fault in a remote device as they can see the process through which the fault or error occurred instead of only seeing the fault state itself, after the fact. It also provides an effective approach for addressing intermittent problems.

Modifications may be incorporated without departing from the scope of the present invention.

What is claimed is:

1. A system for detecting the cause of an error state for, at least, one component within an apparatus, the system comprising:
a plurality of video cameras, for placement at pre-determined locations within the apparatus, the cameras being arranged to shoot footage of areas of the apparatus whilst in operation;
a memory for storing the footage; and
a display arranged to display, at least, a selection of the footage.

2. A system as claimed in claim 1, wherein the display is attached to the apparatus.

3. A system as claimed in claim 1, wherein the display is located at a remote apparatus monitoring centre.

4. A system as claimed in claim 1, wherein system comprises a control processor which is arranged to determine whether footage is required to be displayed on the display.

5. A system as claimed in claim 4, wherein the apparatus comprises a plurality of sensors which determine whether or not the apparatus operated as expected and if not an error state is determined and footage is forwarded to the display.

6. A system as claimed in claim 5, wherein when an error state is determined the output from the sensors is analyzed to determine the likely location of said error and only footage from cameras in the vicinity of the error are sent to the display.

7. A system as claimed in claim 6, wherein footage from additional locations within the apparatus can be displayed on the display on receipt of a request by a user of the system.

8. A system as claimed in claim 4, wherein if footage is not required to be displayed, as no error state has been determined, then it is over written in subsequent operation of the apparatus.

9. A system as claimed in claim 3, wherein a first display is located in a monitoring centre and a second display is located in the vicinity of the apparatus, wherein a user at the monitoring centre can determine the fault from the footage when displayed on the first display and a field engineer can also review the footage at the apparatus.

10. An Automated Teller Machine (ATM) comprising a system for detecting the cause of an error state for, at least, one component within an apparatus, the system comprising:
a plurality of video cameras, for placement at pre-determined locations within the apparatus, the cameras being arranged to shoot footage of areas of the apparatus whilst in operation;
a memory for storing the footage; and
a display arranged to display, at least, a selection the footage.

11. A method of detecting the cause of an error state for, at least, one component within an apparatus, the system comprising:
a plurality of video cameras, for placement at pre-determined locations within the apparatus;
a memory for storing the footage; and
a display arranged to display, at least, a selection the footage;
the method comprising arranging the cameras to shoot footage of areas of the apparatus whilst in operation and to provide, at least, a selection of that footage to the display when an error state is detected within the apparatus.

12. A method as claimed in claim 11, wherein the display is attached to the apparatus.

13. A method as claimed in claim 11, wherein the display is located at a remote apparatus monitoring centre.

14. A method as claimed in claim 11, wherein system comprises a control processor, which is utilized to determine whether footage is required to be displayed on the display.

15. A method as claimed in claim 14, wherein the apparatus comprises a plurality of sensors, which are utilized to determine whether or not the apparatus operated as expected and if not an error state is determined and footage is forwarded to the display.

16. A method as claimed in claim 15, wherein when an error state is determined the output from the sensors is analyzed to determine the likely location of said error and only footage from cameras in the vicinity of the error are sent to the display.

17. A method as claimed in claim 16, wherein footage from additional locations within the apparatus is displayed on the display on receipt of a request by a user of the system.

18. A method as claimed in claim 14, wherein if footage is not required to be displayed, as no error state has been determined, then it is over written in the next operation of the apparatus.

19. A method as claimed in claim 13, wherein a first display is located in a monitoring centre and a second display is located in the vicinity of the apparatus, wherein a user at the monitoring centre can determine the fault from the footage when displayed on the first display and a field engineer can also review the footage at the apparatus.
